(19) United States
(12) Patent Application Publication
(10) Pub. No.: US 2012/0317076 A1
(43) Pub. Date: Dec. 13, 2012

(54) DDL Command Filtering

(75) Inventors: Jianbing Zhu, Shanghai (CN); Stephen Shepherd, Lakewood, CO (US)

(73) Assignee: Sybase, Inc., Dublin, CA (US)

(21) Appl. No.: 13/173,429

(22) Filed: Jun. 30, 2011

Related U.S. Application Data
(60) Provisional application No. 61/494,187, filed on Jun. 7, 2011.

(51) Int. Cl. G06F 17/30

(52) U.S. Cl. 707/626; 707/E17.005

(57) ABSTRACT

System, method and articles of manufacture for filtering a data definition language (DDL) command. The method includes providing a filtering function with one or more rules for filtering the DDL command. The method further includes receiving the DDL command for replication. The method also includes filtering the DDL command from replication based on the one or more rules.

This application claims the benefit of U.S. Provisional Application No. 61/494,187, filed Jun. 7, 2011 which is herein incorporated by reference in its entirety.

### BACKGROUND OF THE INVENTION

1. Field of the Invention

The invention relates generally to databases and more specifically to configuring a replication agent to control the replication of a data definition language (DDL) command.

2. Background Art

A replication agent allows users to maintain data in separate databases. For example, a replication agent replicates data from a primary database to a replicate database. After replication, the replicate database contains accurate and current copies of the subsets of data found in the primary database. When a table in the primary database is marked for replication, replication agent replicates transactions that manipulate the marked table.

Typically, a conventional replication agent replicates all DDL commands with the exception of the commands that the conventional replication agent never replicates. However, a user may not want to replicate the DDL commands related to a particular table in the primary database, even when the table is marked for replication. Therefore, what is needed are systems and methods that allow a user to configure the replication agent to prevent replicating DDL commands for a marked table.

### BRIEF SUMMARY OF THE INVENTION

Embodiments of the invention include systems, methods and computer-readable mediums for configuring a replication agent to replicate desired data definition language (DDL) commands. The replication agent is provided with a filtering function. The filtering function includes one or more rules for filtering the DDL command. The replication agent retrieves the DDL command and filters the DDL command from replication based on the one or more rules.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a block diagram of an exemplary database replication system.

FIG. 2A is a block diagram of an exemplary embodiment of replication agent.

FIG. 2B is a block diagram of an exemplary embodiment of a trigger-based replication agent.

FIG. 2C is a block diagram of an exemplary embodiment of a log-based replication agent.

FIG. 3 is a flowchart of a method for receiving a filtering function using the user interface, according to an embodiment of the invention.

FIG. 4 is a flowchart of a method for filtering DDL commands received from a primary database using a replication agent, according to an embodiment of the invention.

FIG. 5 is an example computer system in which embodiments of the invention can be implemented.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

### Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

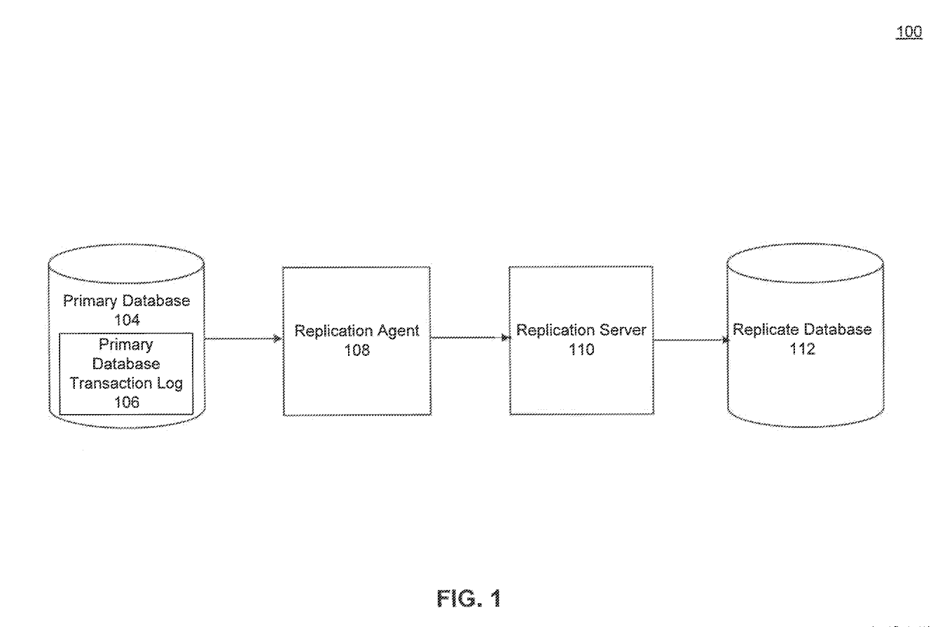

FIG. 1 is a block diagram of an exemplary database replication system 100. Database replication system 100 includes a primary database 104, a replication agent 108, a replication server 110, and a replication database 112.

Primary database 104 may be any type of a database and may include, but is not limited to, a device having a processor and a memory for executing and storing instructions. Primary database 104 may include software, firmware and hardware or any combination thereof. The software may include one or more applications that create, delete and modify database tables and the data stored in those tables. The hardware may include a processor and memory.

Primary database 104 includes tables and schemas that are defined by a developer. Primary database 104 receives transactions from a user or another computing device that may act on the tables and schemas. Those transactions also store, retrieve, modify, and manipulate data stored in primary database 104.

Database replication system 100 replicates transactions in primary database 104 to replicate databases 112. Replication agent 108 marks tables in primary database 104 that include transactions that are captured for replication. Once tables are marked for replication, primary database transaction log 106 stores the record of the transactions that manipulate the marked tables.

Primary database transaction log 106 stores transactions marked for replication. Primary database transaction log 106 may be a text log, a database table, etc. Primary database transaction log 106 may be created and/or maintained by primary database 104 or replication agent 108.

Replication agent 108 replicates transactions for tables and schemas marked for replication in primary database 104. To replicate each transaction, replication agent 108 scans primary database transaction log 106 for the relevant transaction. When replication agent 108 identifies each transaction in primary database transaction log 106, it communicates those transactions to replication server 110. Replication agent 108 may be a stand-alone application that is independent of primary database 104, replication server 110 or other components in database replication system 100. Replication agent 108 may also execute on the same or different computing device as primary database 104.

Replication server 110 receives and processes transactions and data received from replication agent 108. Replication server 110 disseminates those transactions to replicate databases 112 or other replication servers 110. When replication server 110 receives transactions from replication agent 108 it delivers those transactions to replicate databases 112, where they are processed. In an embodiment, replication agent 108 provides instructions to replication server 110 for disseminating replicated transactions to replicate databases 112.

Replication server 110 may guarantee the transaction delivery. When transaction delivery is guaranteed, each transaction successfully received from replication agent 108 is guaranteed for delivery to an appropriate replicate database 112.

Replicate database 112 receives transactions from replication server 110 and updates the tables and data with the content included in the transactions. When transactions are successfully processed by replicate database 112, the state of the tables included in replicate database 112 is the same as that of the tables marked for replication on primary database 104.

Database replication system 100 may also include a network (not shown). The network may be any type of a network or combination of networks such as, but not limited to, a local area network, wide area network or the Internet. Network may be any form of a wired network or a wireless network, or a combination thereof. Network allows primary database, replication agent, replication server and replication database to communicate among each other.

### Replicating Transactions on a Replication Agent

In a conventional system a user can only enable all DDL commands for replication or disable all DDL commands from replication. If a user enables DDL replication, then all DDL commands that manipulate the marked table will be replicated by a conventional replication agent. Similarly, if a user disables DDL replication, then none of the DDL commands will be replicated by the conventional replication agent. A limited exception may exist for certain DDL commands that are never replicated by the conventional replication agent.

Unlike conventional systems, a user may configure replication agent 108 to manage replication of a certain set of DDL commands on a table that is marked for replication in primary database 104. Unlike conventional systems, this functionality exists even for DDL commands that are not in the set of DDL commands that are never replicated. For example, a user may configure replication agent 108 using rules that prevents replication agent 108 from replicating specific DDL commands and propagating those commands to replication server 110.

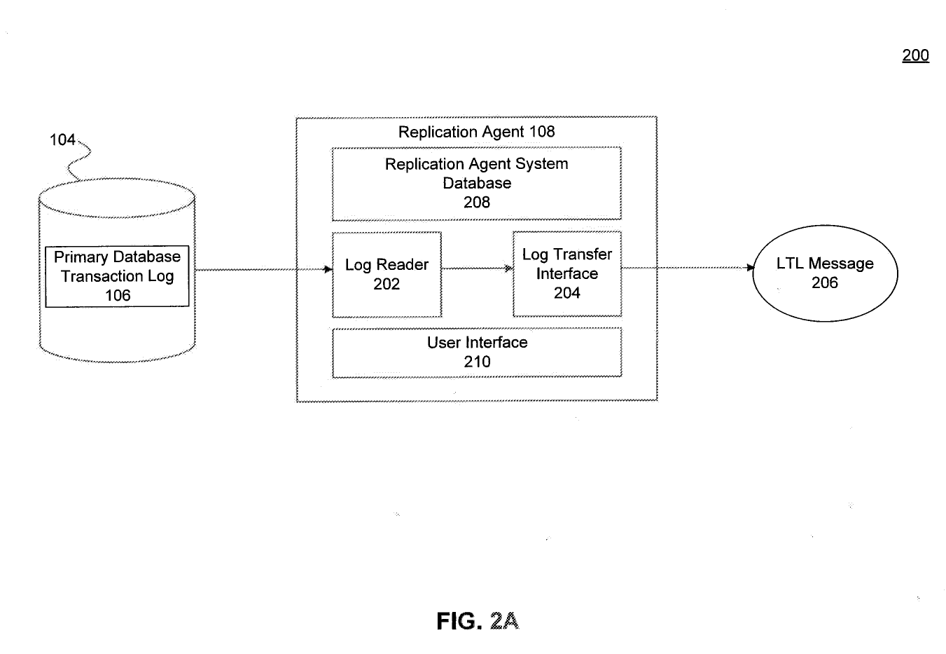

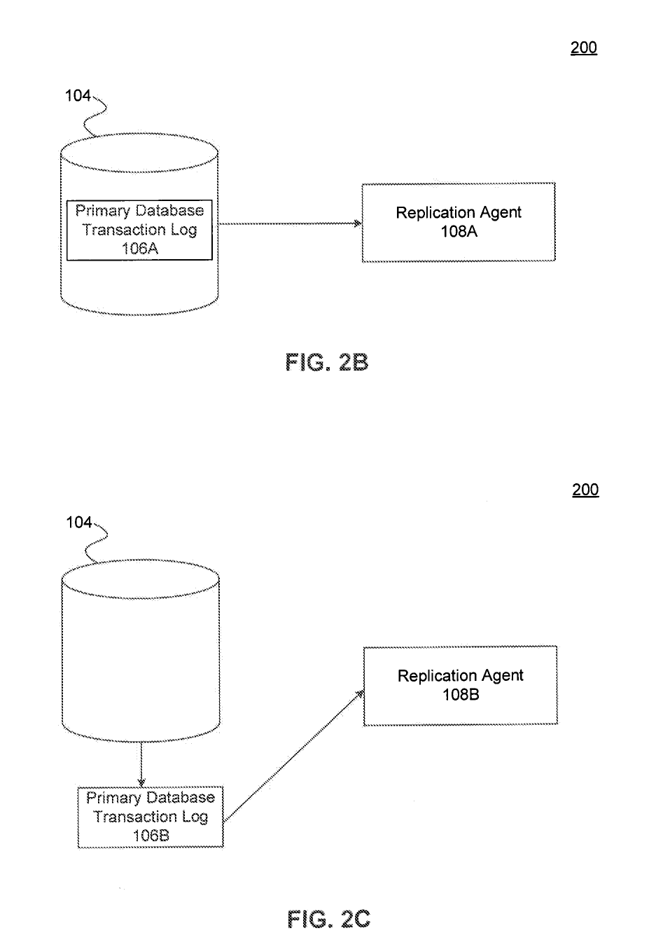

FIG. 2A is a block diagram of an exemplary embodiment 200 of replication agent 108. As described herein, replication agent 108 captures transactions from primary database 104 and replicates those transactions to replication server 110. Replication agent 108 may be a trigger-based replication agent or a log-based replication agent. Elements of the invention may be implemented using, for example, the Sybase Replication Agent product from Sybase, Inc. of Dublin, Calif. However, the invention is not limited to this example implementation.

FIG. 2B is an exemplary embodiment of a trigger-based replication agent 108a. Trigger-based replication agent 108a uses triggers on marked tables in primary database 104 to capture transactions for replication. The triggers also record other information that replication agent 108a requires to replicate a transaction, such as a transaction ID that identifies the operations associated with the transaction. The triggers record the data that requires replication in primary database transaction log 106a in primary database 104.

When replication agent 108a uses trigger-based replication agent 108a, primary database transaction log 106a is a user created table in primary database 104 that is maintained by replication agent 108a. Replication agent 108a creates the data-capture triggers in primary database 104 when a user marks a table or stored procedure for replication. Similarly, replication agent 108a removes the data-capture triggers from the marked table or procedure when a user decides that replication is no longer required. Triggers allow replication agent 108a to determine the DDL commands that are executed on the marked tables or procedures. Example primary databases that may use replication agent 108a include a DB2 database, Microsoft SQL Server or Oracle RDBMS, although the invention is not limited to these examples.

FIG. 2C is an exemplary embodiment of a log-based replication agent 108b. Log-based replication agent 108b periodically retrieves transactions from a primary database transaction log 106b. Primary server 104 creates primary database transaction log 106b and saves transactions into primary database transaction log 106b when the transactions are issued and executed. Example primary databases 104 that may use replication agent 108b are DB2 Universal Database, manufactured by IBM, and Oracle databases, although the invention is not limited to these examples.

Going back to FIG. 2A, replication agent 108 includes a log reader 202, a log transfer interface 204, a replication agent system database (RASD) 208 and a user interface 210. Log reader 202 retrieves transactions from primary database transaction log 106 in primary database 104 and generates a change data set. Log reader 202 passes the change data set to log transfer interface 204.

Log transfer interface 204 receives the change data set from log reader 202. Log transfer interface 204 uses the log transfer language (LTL) to encapsulate the change data set into an LTL message 206. Once LTL message 206 is generated, log transfer interface 204 sends LTL message 206 to primary replication server 110.

In some embodiments, replication agent 108 includes RASD 208. RASD 208 stores information associated with structure, schemas and tables in primary database 104. When an instance of replication agent 108 is created for primary database 104, a user initializes RASD 208 with schema and table information included in primary database 104. The DDL commands that update schemas and tables in primary database 104 are also stored in primary database transaction log 106. When replication agent 108 retrieves those DDL commands from primary database transaction log 106 it updates the schemas and tables pertaining to primary database 104 in RASD 208.

RASD 208 may also include a configuration table that stores configuration rules set by a user for replicating DDL commands, as described herein.

User interface 210 enables a user to issue functions that configure replication agent 108. For example, a user uses user interface 210 to issue a filtering function that manages replication agent 108 when replicating a DDL command. A filtering function includes rules that allow replication agent 108 to skip a DDL command included in log reader 202. In one embodiment, the filtering function may be “pdb_setrepddl.”

For example, a user uses user interface 210 to provide a filtering function that includes rules for filtering DDL commands related to a particular owner. An example filtering function may be:
‘pdb_setrepddl owner, OWNER_NAME, enable|disable’

where the rules indicate that the filtering function applies to an owner, and include the name of the owner and instruction to enable or disable the replication.

In another example, a user uses user interface 210 to provide a filtering function that includes rules that prevent replication of DDL commands related to a certain database object, such as, a table, a procedure call or a sequence. An example filtering function may be:
‘pdb_setrepddl TABLE_NAME|PROC_NAME|SEQ_NAME, enable|disable’

where the rules include a name of the table, a name of the stored procedure or a name of a sequence, and instruction to enable or disable the replication.

In another example, a user uses user interface 210 to provide a filtering function that includes rules that prevent replication of a particular DDL command. An example filtering function may be:
‘pdb_setrepddl stmt, CERTAIN_DDL, enable|disable’

where the rules indicate that the function applies to a DDL command, a name of the DDL command and instruction to enable or disable the replication.

In another example, a user uses user interface 210 to provide a filtering function that includes rules that prevent replication of a particular set of DDL commands. An example filtering function may be:
‘pdb_setrepddl stmt, DDL_KEYWORD, enable|disable’

where the rules indicate that a filtering function applies to DDL commands, a keyword that includes in the DDL command and an instruction to enable or disable the replication.

In another example, a user uses user interface 210 to provide a filtering function that includes rules that prevent replication of DDL commands executed by a particular database user. An example filtering function may be:
‘pdb_setrepddl user, USER_NAME, enable|disable’

where the rules indicate that a filtering function applies to a user and include the name of the user and instruction to enable or disable the replication.

In another example a user uses user interface 210 to provide a filtering function that includes rules that override a prior version of a filtering function. For example, to disable replication of DDL commands generated by all users, an example filtering function may be:
‘pdb_setrepddl user, all, disable override’

where the rules indicate that the filtering function is applied to a user, and enables filtering for all users, irrespective of whether the DDL command for a particular user is being filtered or not.

When replication agent 108 receives the filtering function, replication agent 108 stores the filtering function and the associated rules in the configuration table included in RASD 208. When log reader 202 retrieves a DDL command that includes a credential that is stored in the configuration table, log reader 202 prevents the replication of the DDL command by failing to forward the DDL command to log transfer interface 204. Because the DDL command is not passed to log transfer interface 204 it is not received by the replication server 110 and is not forwarded to replicate database 112.

In an embodiment, the filtering function prevents replication of a DDL command that performs an action on a schema. When processing those DDL commands, replication agent 108 synchronizes the schema of primary database 104 stored in RASD 208 with the changes to primary database 104 as described the DDL command. However, log reader 202 does not forward the DDL command to log transfer interface 204.

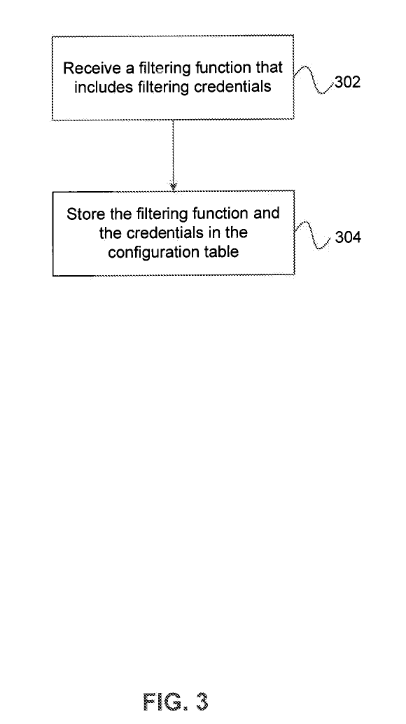

FIG. 3 is an exemplary flowchart of a method 300 for receiving a filtering function.

At step 302, user enters a filtering function using user interface 210. As described herein, the filtering function includes a set of rules for filtering DDL commands.

At step 304, replication agent 108 stores the filtering function in RASD 208. For example, RASD 208 stores the filtering function and the associated rules in the configuration table. As described herein, based on the filtering functions and associated rules, replication agent 108 replicates the DDL commands that it receives from primary database 104.

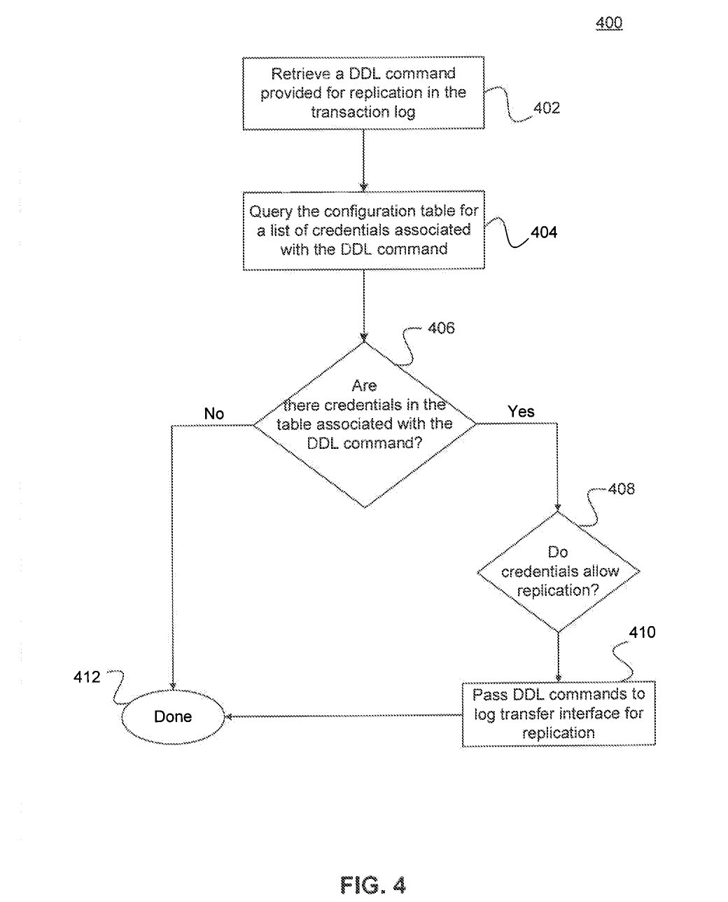

FIG. 4 is an exemplary flowchart of a method 400 for filtering DDL commands received from primary database 104.

At step 402, log reader 202 retrieves a DDL command provided for replication. For example, primary database 104 stores a list of DDL commands that are marked for replication in primary database transaction log 106. Log reader 202 retrieves the DDL command in primary database transaction log 106 by querying a transaction log table in trigger-based replication agent 108a or scanning the transaction log file in log-based replication agent 108b.

At step 404, replication agent 108 queries configuration table for a list of rules associated with a DDL command. For example, log reader 202 retrieves rules associated with the DDL command of step 402 and queries the configuration table.

At step 406, replication agent 108 determines whether the configuration table includes rules associated with the DDL command. If configuration table includes one or more rules associated with DDL command, method 400 proceeds to step 408. Otherwise, the method ends at step 412.

At step 408, the rules are applied to the DDL command. For example, if the rules allow replication, the method proceeds to step 410. Otherwise, the DDL commands are not replicated by replication agent 108 as described herein, and the method ends at step 412.

As step 410, log reader 202 passes the DDL command for replication to log transfer interface 204.

At step 412, the replication process is complete with the replication agent 108 sending the DDL command to replication server 110.

### Computer System

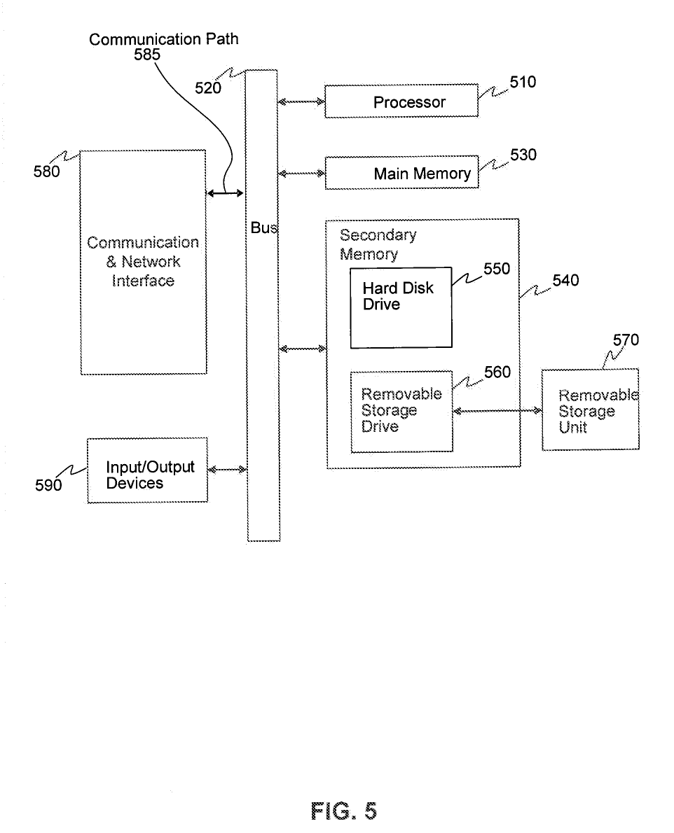

Various aspects of the invention can be implemented by software, firmware, hardware, or a combination thereof. FIG. 5 illustrates an example computer system 500 in which the invention, or portions thereof, can be implemented as computer-readable code. For example, the methods illustrated by flowcharts described herein can be implemented in system 500. Various embodiments of the invention are described in terms of this example computer system 500. After reading this description, it will become apparent to a person skilled in the relevant art how to implement the invention using other computer systems and/or computer architectures.

Computer system 500 includes one or more processors, such as processor 510. Processor 510 can be a special purpose or a general purpose processor. Processor 510 is connected to a communication infrastructure 520 (for example, a bus or network).

Computer system 500 also includes a main memory 530, preferably random access memory (RAM), and may also include a secondary memory 540. Secondary memory 540 may include, for example, a hard disk drive 550, a removable storage drive 560, and/or a memory stick. Removable storage drive 560 may comprise a floppy disk drive, a magnetic tape drive, an optical disk drive, a flash memory, or the like. The removable storage drive 560 reads from and/or writes to a removable storage unit 570 in a well known manner. Removable storage unit 570 may comprise a floppy disk, magnetic tape, optical disk, etc. which is read by and written to by removable storage drive 560. As will be appreciated by persons skilled in the relevant art(s), removable storage unit 570 includes a computer usable storage medium having stored therein computer software and/or data.

In alternative implementations, secondary memory 540 may include other similar means for allowing computer programs or other instructions to be loaded into computer system 500. Such means may include, for example, a removable storage unit 570 and an interface (not shown). Examples of such means may include a program cartridge and cartridge interface (such as that found in video game devices), a removable memory chip (such as an EPROM, or PROM) and associated socket, and other removable storage units 570 and interfaces which allow software and data to be transferred from the removable storage unit 570 to computer system 500.

Computer system 500 may also include a communications and network interface 580. Communications interface 580 allows software and data to be transferred between computer system 500 and external devices. Communications interface 580 may include a modem, a communications port, a PCMCIA slot and card, or the like. Software and data transferred via communications interface 580 are in the form of signals which may be electronic, electromagnetic, optical, or other signals capable of being received by communications interface 580. These signals are provided to communications interface 580 via a communications path 585. Communications path 585 carries signals and may be implemented using wire or cable, fiber optics, a phone line, a cellular phone link, an RF link or other communications channels.

The network interface 580 allows the computer system 500 to communicate over communication networks or mediums such as LANs, WANs the Internet, etc. The network interface 580 may interface with remote sites or networks via wired or wireless connections.

In this document, the terms “computer program medium” and “computer usable medium” and “computer readable medium” are used to generally refer to media such as removable storage unit 570, removable storage drive 560, and a hard disk installed in hard disk drive 550. Signals carried over communications path 585 can also embody the logic described herein. Computer program medium and computer usable medium can also refer to memories, such as main memory 530 and secondary memory 540, which can be memory semiconductors (e.g. DRAMs, etc.). These computer program products are means for providing software to computer system 500.

Computer programs (also called computer control logic) are stored in main memory 530 and/or secondary memory 540. Computer programs may also be received via communications interface 580. Such computer programs, when executed, enable computer system 500 to implement embodiments of the invention as discussed herein. In particular, the computer programs, when executed, enable processor 440 to implement the processes of the invention, such as the steps in the methods illustrated by flowcharts discussed above. Accordingly, such computer programs represent controllers of the computer system 500. Where the invention is implemented using software, the software may be stored in a computer program product and loaded into computer system 500 using removable storage drive 560, interfaces, hard drive 550 or communications interface 580, for example.

The computer system 500 may also include input/output/display devices 590, such as keyboards, monitors, pointing devices, etc.

The invention is also directed to computer program products comprising software stored on any computer useable medium. Such software, when executed in one or more data processing device(s), causes a data processing device(s) to operate as described herein. Embodiments of the invention employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention can work with software, hardware, and/or operating system implementations other than those described herein. Any software, hardware, and operating system implementations suitable for performing the functions described herein can be used.

### CONCLUSION

It is to be appreciated that the Detailed Description section, and not the Summary and Abstract sections, is intended to be used to interpret the claims. The Summary and Abstract sections may set forth one or more but not all exemplary embodiments of the invention as contemplated by the inventor(s), and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the invention should not be limited by any of the above-described exemplary embodiments, but should be defined only in accordance with the following claims and their equivalents.

1. A method for controlling replication of a data definition language (DDL) command, comprising:
providing a filtering function including one or more rules for filtering a DDL command during replication, wherein the one or more rules in the filtering function are configured using a user interface;
retrieving a DDL command provided for replication, wherein the DDL command is stored in a computer memory; and
managing replication of the DDL command based on the one or more rules included in the filtering function, wherein managing replication of the DDL command executes on one or more processors.

2. The method of claim 1, wherein managing further comprises enabling a replication of the DDL command based on at least one of a group comprising a user, an object, a DDL command, and an owner.

3. The method of claim 2, wherein the object includes a table, a procedure or a sequence.

4. The method of claim 1, wherein managing further comprises overriding a prior version of the filtering function.

5. The method of claim 1, further comprising storing the one or more rules in a database table.

6. A replication system for controlling replication of a data definition language (DDL) command, comprising:
one or more processors;
a memory coupled to the one or more processors;
a configuration table stored in memory and configured to provide a filtering function including one or more rules for filtering a DDL command during replication, wherein the one or more rules in the filtering function are configured using a user interface;
a log reader configured to retrieve a DDL command provided for replication; and
a replication agent configured to manage replication of the DDL command based on the one or more rules included in the filtering function,
wherein the log reader is stored in the computer memory and the replication agent executes on the one or more processors.

7. The replication system of claim 6, wherein the one or more rules are related to a user.

8. The replication system of claim 6, wherein the one or more rules are related to an object, the object including a table, a procedure or a sequence.

9. The replication system of claim 6, wherein the one or more rules are related to a DDL command.

10. The replication system of claim 6, wherein the one or more rules are related to an owner.

11. The replication system of claim 6, wherein the one or more rules are related to overriding a prior version of a filtering function that enables or disables the DLL command.

12. The replication system of claim 6, wherein the memory is further configured to store the one or more rules in a database table.

13. An article of manufacture including a non-transitory computer-readable medium having instructions stored thereon that, when executed by a computing device, cause the computing device to perform operations for controlling replication of a data definition language (DDL) command comprising:
providing a filtering function including one or more rules for filtering a DDL command during replication, wherein the one or more rules in the filtering function are configured using a user interface;
retrieving a DDL command provided for replication, wherein the DDL command is stored in a computer memory; and
managing replication of the DDL command based on the one or more rules included in the filtering function, wherein managing replication of the DDL command executes on one or more processors.

14. The article of manufacture including the computer-readable medium of claim 13, wherein managing further comprises enabling a replication of the DDL command based on at least one of a group comprising a user, an object, a DDL command, and an owner.

15. The article of manufacture including the computer-readable medium of claim 14, wherein the one or more rules are related to an object, the object being a table, a procedure or a sequence.

16. The article of manufacture including the computer-readable medium of claim 15, the operations further comprising storing the one or more rules in a database table.

17. The article of manufacture including the computer-readable medium of claim 14, wherein the managing further comprises overriding a prior version of the filtering function.

18. The method of claim 1, wherein managing replication further comprises:
querying the one or more rules included in the filtering function provided using the user interface;
determining whether the one or more rules are associated with the DDL command; and
applying the one or more rules to the associated DDL command, wherein the one or more rules enable or disable the replication of the DDL, command.

19. The system of claim 6, wherein the replication agent is further configured to:
query the one or more rules included in the filtering function provided using the user interface;
determine whether the one or more rules are associated with the DDL command; and
apply the one or more rules to the associated DDL command, wherein the one or more rules enable or disable the replication of the DDL command.

20. The article of manufacture including the computer-readable medium of claim 13, wherein the instructions further include operations comprising:
querying the one or more rules included in the filtering function provided using the user interface;
determining whether the one or more rules are associated with the DDL command; and
applying the one or more rules to the associated DDL command, wherein the one or more rules enable or disable the replication of the DDL command.
